(19) United States
(12) Patent Application Publication
(10) Pub. No.: US 2009/0237709 A1
(43) Pub. Date: Sep. 24, 2009

(54) INSTRUCTION INFORMATION MANAGEMENT APPARATUS, INSTRUCTION INFORMATION MANAGING METHOD AND COMPUTER READABLE MEDIUM

(75) Inventor: Kenzo MIYAZONO, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/212,221

(22) Filed: Sep. 17, 2008

(30) Foreign Application Priority Data
Mar. 24, 2008 (JP) 2008-076635

(51) Int. Cl. G06F 3/12

(52) U.S. Cl. 358/1.15

(57) ABSTRACT

a computer readable medium storing a program causing a computer to execute a process for controlling print mode, the process includes: accumulating successively inputted print instruction information items in an accumulation region until an output instruction to a print device is issued; outputting to the print device in an instructed mode of a first mode and a second mode based on the output instruction. Selected instruction print information items out of the accumulated print instruction information items are outputted in the first mode, and all the accumulated print instruction information items are outputted in the second mode.

### CROSS-REFERENCE TO RELATED APPLICATIONS

This application is based on and claims priority under 35 USC 119 from Japanese Patent Application No. 2008-076635 filed Mar. 24, 2008.

### BACKGROUND

1. Technical Field

The present invention relates to an instruction information management apparatus and a computer readable medium.

2. Related Art

There is known an image processing apparatus capable of displaying plural print jobs in a list, and selecting a print job targeted for printing on the list.

### SUMMARY

According to an aspect of the invention, a computer readable medium storing a program causing a computer to execute a process for controlling print mode, the process includes: accumulating successively inputted print instruction information items in an accumulation region until an output instruction to a print device is issued; outputting to the print device in an instructed mode of a first mode and a second mode based on the output instruction. Selected instruction print information items out of the accumulated print instruction information items are outputted in the first mode, and all the accumulated print instruction information items are outputted in the second mode.

### BRIEF DESCRIPTION OF THE DRAWINGS

Exemplary embodiments of the present invention will be described in detail based on the following figures, wherein:

FIG. 1 is a general view showing one example of a schematic configuration of a print system in accordance with a first exemplary embodiment of the present invention;

FIG. 2 is a block view showing one example of a schematic configuration of a print server;

FIG. 3A is a view showing one example of a first spooler, FIG. 3B is a view showing one example of a second spoolers and FIG. 3C is a view showing one example of threshold value information;

FIG. 4 is a view showing one example of a print setting screen;

FIG. 5 is a view showing one example of a data structure of a print job;

FIG. 6 is a flowchart showing one example of a registration processing of a print job;

FIG. 7 is a flowchart showing one example of an output processing of a print job;

FIG. 8 is a general view showing one example of a schematic configuration of a print system in accordance with a second exemplary embodiment of the invention; and

FIG. 9 is a block view showing one example of a schematic configuration of a printer.

### DETAILED DESCRIPTION

### First Exemplary Embodiment

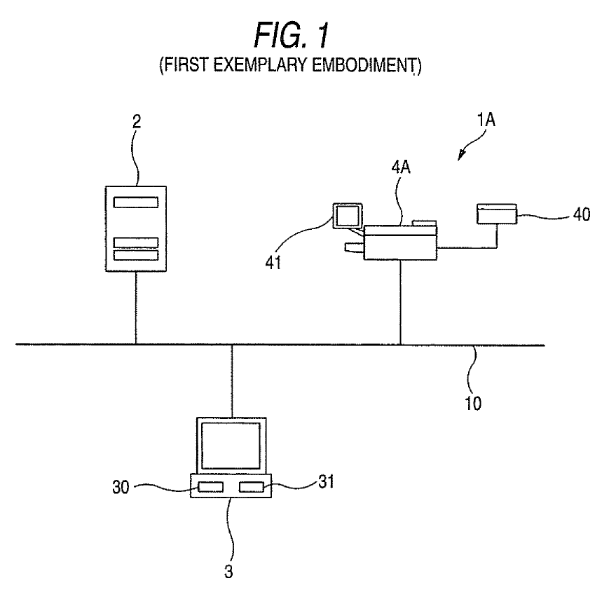

FIG. 1 is a general view showing one example of a schematic configuration of a print system in accordance with a first exemplary embodiment of the present invention. The print system 1A includes a terminal 3 for transmitting a print job, a print server (one example of the instruction information management apparatus) 2 for managing the print job transmitted from the terminal 3, and transmitting the print job in response to a print instruction (output instruction) from a printer 4A, the printer 4A for executing a print processing based on the print job, and a network 10 for connecting the print server 2, the terminal 3, and the printer 4A to one another.

Herein, the term “print job” denotes print instruction information for instructing a print processing to the printer 4A. It includes document data as a target of printing, and printing conditions for printing print data on sheets such as paper sheets.

Incidentally, the print job may include, in place of document data, print data obtained by describing the document data in a page description language (such as PDL) interpretable by the printer, or image data (e.g., bit map data) converted from print data into a form capable of being printed out at a print output unit. Alternatively, the following may also be acceptable. The storage site information (e.g., URL) of actual data such as document data and identification information of actual data is transmitted, and real data is acquired based on the storage site information or the identification information on the receiving side. In this exemplary embodiment, the print job transmitted from the terminal 3 to the print server 2 also includes document data. The print job transmitted from the print server 2 to the printer 4A includes print data obtained by converting the document data into a page description language.

The document data targeted for printing or the like is obtained by storing documents, pictures, diagrams, or the like as digital data. It is not limited thereto so long as data to be targeted for a printing processing is stored therein.

The network 10 is a communication line such as a LAN (local area network) or the Internet for performing transmission and reception of data by wired communication, wireless communication, and the like. Incidentally, in FIG. 1, the numbers of the terminal 3 and the printer 4A are one, respectively. However, the numbers may also be two or more. (Terminal) The terminal 3 includes (i) a control unit implemented by, for example, a CPU, which controls respective units of the terminal 3, (ii) a storage unit implemented by, for example, a ROM, a RAM, a hard disk, or the like, for storing programs and data such as a web browser 30 and a document formation application 31, (iii) a communication unit implemented by, for example, a network interface card, connected to the network 10, (iv) an input unit including, for example, a keyboard, a mouse, and the like, for receiving data input and operation instructions, and (v) a display unit implemented by, for example, a liquid crystal display, for displaying a screen or the like.

Such a terminal 3 can be constituted by, for example, a computer, a personal digital assistant (PDA), or a cellular phone.

The control unit of the terminal 3 operates according to the web browser 30, and thereby designates a prescribed URL, and transmits a transmission request of the screen information to the print server 2, displays various screens based on the screen information received as a reply in response to the transmission request. Then, it transmits input information with respect to the screens to the print server 2.

Further, the control unit of the terminal 3 operates according to the document formation application 31, and thereby forms document data, and stores the formed document data in the storage unit of the terminal 3. Incidentally, the document data may be stored in other terminals or the print server 2 connected to the network 10, or may be captured via external storage media or the like.

(Printer)

The printer 4A includes a card read unit 40 for reading, from an IC chip embedded in the authentication card which each user has, the user name recorded on the IC chip in a non-contact manner, and a display operation unit 41 including, for example, a touch panel display configured such that touch panels are superposed on the surface of the display, and a hard key such as a start key.

Whereas, the printer 4A includes, other than the card read unit 40 and the display operation unit 41, a control unit implemented by, for example, a CPU, for controlling respective units of the printer 4A, a storage unit implemented by a ROM, a RAM, a hard disk, or the like, for storing programs such as printer control programs and data, a print unit for printing a visible image based on print data on a sheet, and a communication unit implemented by, for example, a network interface card, connected to the network 10.

The control unit of the printer 4A operates according to the printer control program, and thereby displays various screens based on the image information transmitted from the print server 2. In addition, it executes a print processing according to the print job transmitted from the print server 2.

For the printer 4A, there can be used various systems such as electrophotography system, ink jet system, and heat sensitive transfer system. Incidentally, in place of the printer 4A, a multiple function device having a plurality of functions such as copy (duplication), print, scanning, and faxing may be used.

### (Print Server)

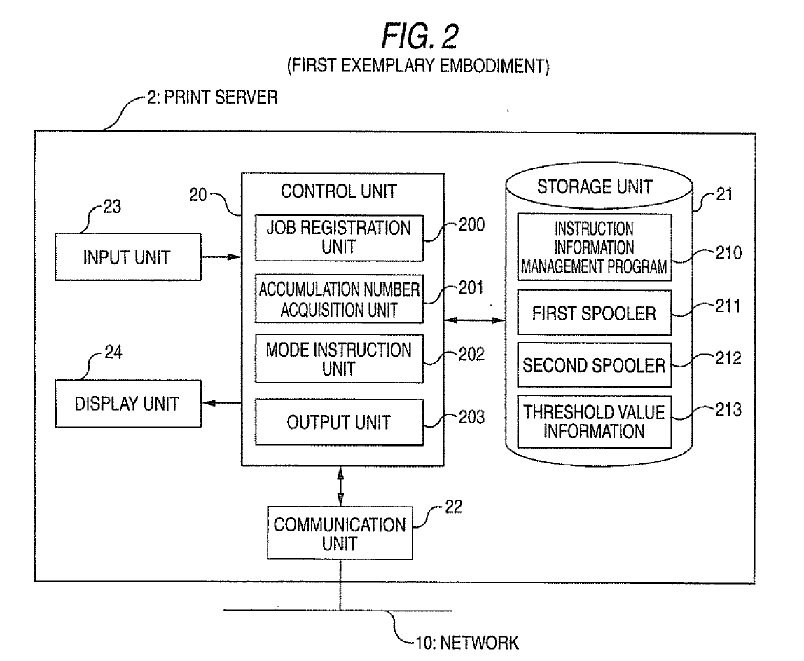

FIG. 2 is a block view showing one example of a schematic configuration of the print server 2. The print server 2 includes a control unit 20 implemented by, for example, a CPU, for controlling respective units of the print server 2, a storage unit 21 implemented by, for example, a ROM, a RAM, a hard disk, or the like, for storing various programs and data, a communication unit 22 implemented by, for example, a network interface card, for performing transmission and reception of data being connected to the network 10, an input unit 23 including, for example, a keyboard, a mouse, and the like, for receiving data input and operation instructions, and a display unit 24 implemented by, for example, a liquid crystal display, for displaying the processing results by the control unit 20, and the like.

Such a print server 2 can be formed of, other than the server, for example, a computer or a work station (WS).

The storage unit 21 stores therein an instruction information management program 210, a first spooler 211, a second spooler 212, threshold value information 213, and the like.

The control unit 20 functions as a job registration unit 200 which operates according to the instruction information management program 210 stored in the storage unit 21, and thereby registers the successively inputted print jobs in any of the first and second spoolers 211 and 212 in order to accumulate them until a print instruction from the printer 4A is given, an accumulation number acquisition unit 201 for respectively acquiring the accumulation number information indicative of the number of the print jobs accumulated in the first and second spoolers 211 and 212, a mode instruction unit 202 for instructing an operation mode to an output unit 203 based on the accumulation number information acquired by the accumulation number acquisition unit 201 and the threshold value information 213, the output unit 203 for outputting print jobs according to the operation mode instructed by the mode instruction unit 202, and the like.

The operation modes when the output unit 203 outputs print jobs, include a job selection mode (first mode) for outputting a selected print job out of the print jobs accumulated in the first spooler 211, and an instant print mode (second mode) for outputting all the print jobs accumulated in the first and second spoolers 211 and 212.

Incidentally, in this exemplary embodiment, the output unit 203 outputs a print job under instructions based on the accumulation number information and the threshold information 213 by the mode instruction unit 202. However, it may be configured such that the output unit 203 outputs a print job by the operation mode instructed by a user.

Further, in this exemplary embodiment, the accumulation number information acquired by the accumulation number acquisition unit 201 indicates the number of print jobs. However, any information is acceptable so long as it is an index indicating the accumulation state of the print jobs. For example, it may be the file size of the print job, or it may be the ratio of the print jobs relative to the storage capacitance of the first and second spoolers 211 and 212.

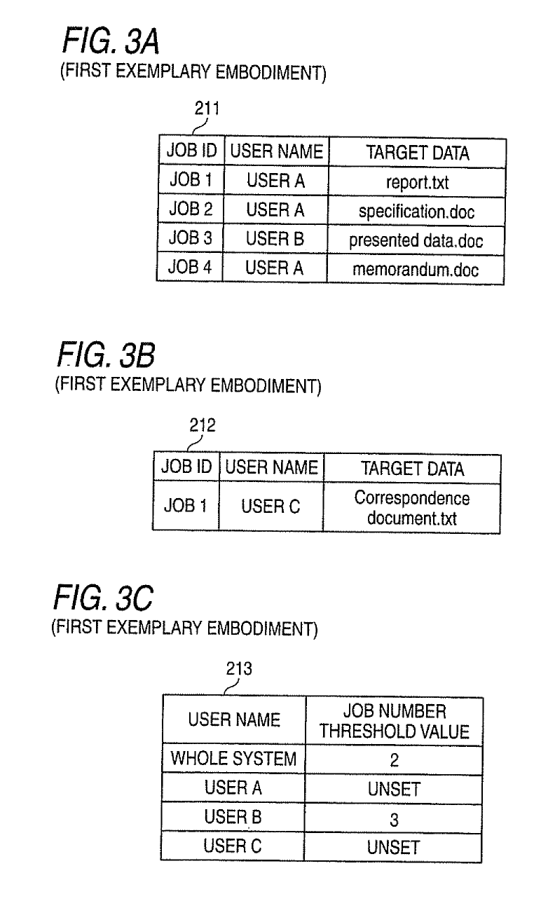

FIG. 3A is a view showing one example of the first spooler 211. The first spooler 211 is a first accumulation region for accumulating the print jobs to be outputted in the job selection mode. In the first spooler 211, there are provided fields such as an instruction user indicating a user who has inputted the print job and target data which is document data targeted for printing with the job ID for identification of each print job as a key.

FIG. 3B is a view showing one example of the second spooler 212. The second spooler 212 is a second accumulation region for accumulating the print jobs to be outputted in the instant print mode. As with the first spooler 211, there are provided fields such as an instruction user and target data with the job ID as a key.

FIG. 3C is a view showing one example of the threshold value information. The threshold value information 213 stores the job number threshold value indicative of the threshold value for switching the operation mode for every user. To the user for whom the job number threshold value has not been set yet, the job number threshold value for the whole system is applied. Incidentally, the threshold value information 213 may be editable via an edit screen, or it may be instructed in accordance with the time when a print job is inputted.

(Operation of First Exemplary Embodiment)

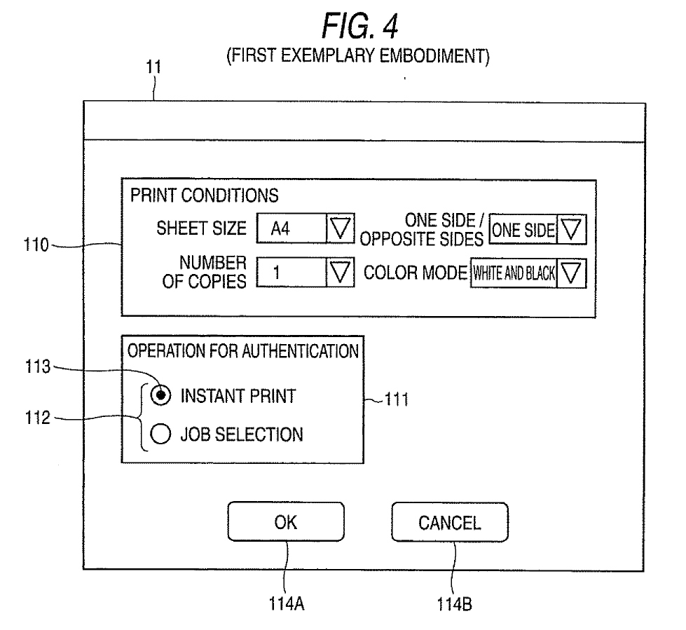

Then, a description will be given to one example of an operation of the print system 1A in accordance with the first exemplary embodiment of the invention by reference to FIGS. 4 to 7.

(1) Registration Processing of Print Job

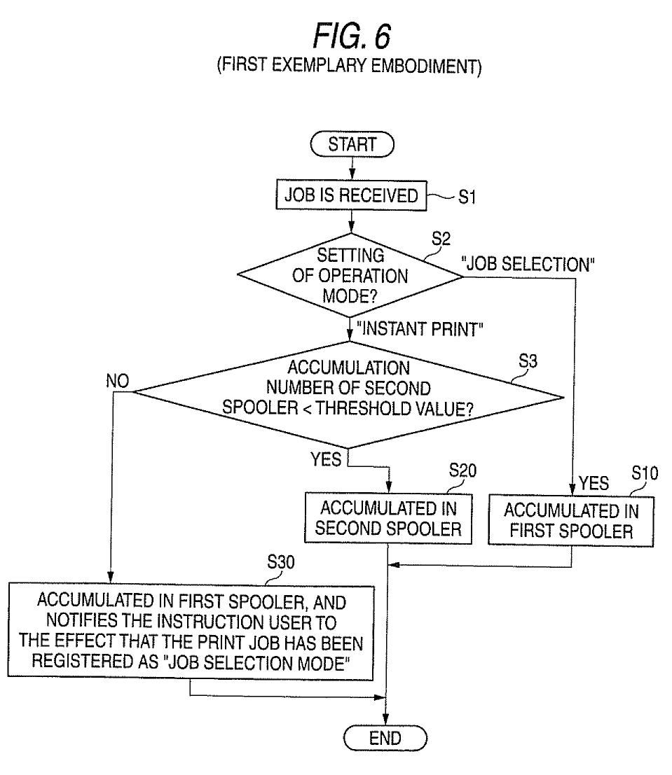

First, a description will be given to one example of the registration processing of a print job according to the flowchart of FIG. 6. When a user instructs input of a print job using the terminal 3, the web browser 30 of the terminal 3 transmits a transmission request designating a prescribed URL to the print server 2.

Then, the control unit 20 of the print server 2 transmits screen information for displaying a print setting screen to the terminal 3 in response to the received transmission request.

Then, the web browser 30 displays the print setting screen on the display unit based on the received screen information.

FIG. 4 is a view showing one example of the print setting screen. In the print setting screen 11, there are provided a print condition setting region 110 for instructing the print conditions, an operation mode setting region 111 for instructing the operation mode, an OK button 114A for determining input of the print job as the instructed content, and a cancel button 114B for interrupting input of the print job.

The print condition setting region 110 is a region for instructing the print conditions such as the sheet size, the number of copies, and single side or opposite sides, and the color mode.

The operation mode setting region 111 is a region for instructing either operation mode of the operation modes 112 including the “instant print” or the “job selection” by a radio button 113.

Then, when the web browser 30 receives input information inputted to the print condition setting region 110 and the operation mode setting region 111 by a user, it reads the document data targeted for printing from the storage unit of the terminal 3. Then, it transmits a print job including the input information and the document data to the print server 2 via the network 10.

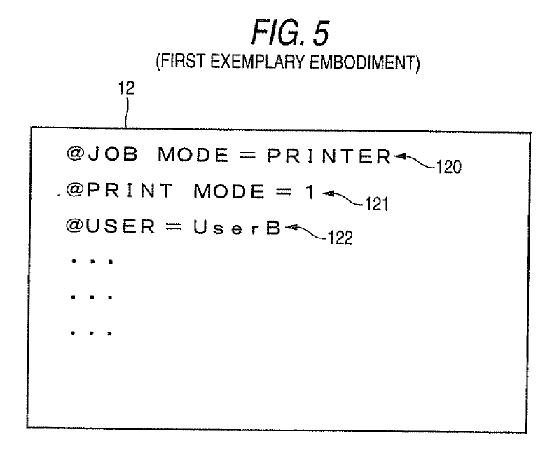

Herein, FIG. 5 is a view showing one example of the data structure of the print job. In the print job 12, there are recorded a job mode 120 indicating that the data is the data of the print job, an operation mode 121 for showing the “instant print” and the “job selection” instructed in the operation mode setting region 111 as, for example, “0” and “1”, respectively, an instruction user 122 who has instructed input of the print job, and the like.

Incidentally, in the print job 12, there are also recorded, other than the foregoing, the print conditions instructed at the print condition setting region 110, and the like. Whereas, document data may be transmitted as different data from the print job 12. Alternatively, it may be included in the print job 12 to be transmitted as one data.

Then, when the control unit 20 of the print server 2 receives a print job transmitted from the terminal 3 through the communication unit 22 (S1), the job registration unit 200 checks the setting of the operation mode 121 of the print job (S2).

Then, when the operation mode 121 shows a job selection mode (S2: job selection), the job registration unit 200 assigns a new job ID to the print job, and registers it to the first spooler 211 (S110).

Whereas, when the operation mode 121 shows an instant print mode (S2: instant print), the accumulation number acquisition unit 201 acquires the number of the accumulated print jobs of the user corresponding to the instruction user 122 in the second spooler 212. Then, the mode instruction unit 202 compares the acquired accumulation number with the job number threshold value of the threshold value information 213 (S3).

Then, when the accumulation number of the second spooler 212 is less than the job number threshold value (S3: Yes), the job registration unit 200 assigns a new job ID to the print job, and registers it to the second spooler 212 (S20). On the other hand, when the accumulation number of the second spooler 212 is equal to or more than the job number threshold value (S3: No), the job registration unit 200 registers the print job to the first spooler 211, and notifies the instruction user 122 to the effect that the print job has been registered as a job of not the “instant print” but the “job selection mode” (S30)

In the foregoing manner, print jobs are successively transmitted from the terminal 3. The transmitted print jobs are separated into the first and second spoolers 211 and 212 to be accumulated by the job registration unit 200. As a result, in the second spooler 212, there are registered only the pint jobs to be outputted in the instant print mode in which a print job is not required to be selected when a user issues a print instruction. Therefore, when a print job is outputted in the instant print mode, the print job is outputted from the second spooler 212 without selection of a job to be printed by the user. Further, in the step S3, when the accumulation number of the second spooler 212 is equal to or more than the job number threshold value (S3: No), the following is acceptable. The job registration unit 200 registers the print job in the first spooler 211, and moves the print jobs already accumulated in the second spooler 212 into the first spooler 211.

(2) Output Processing of Print Job

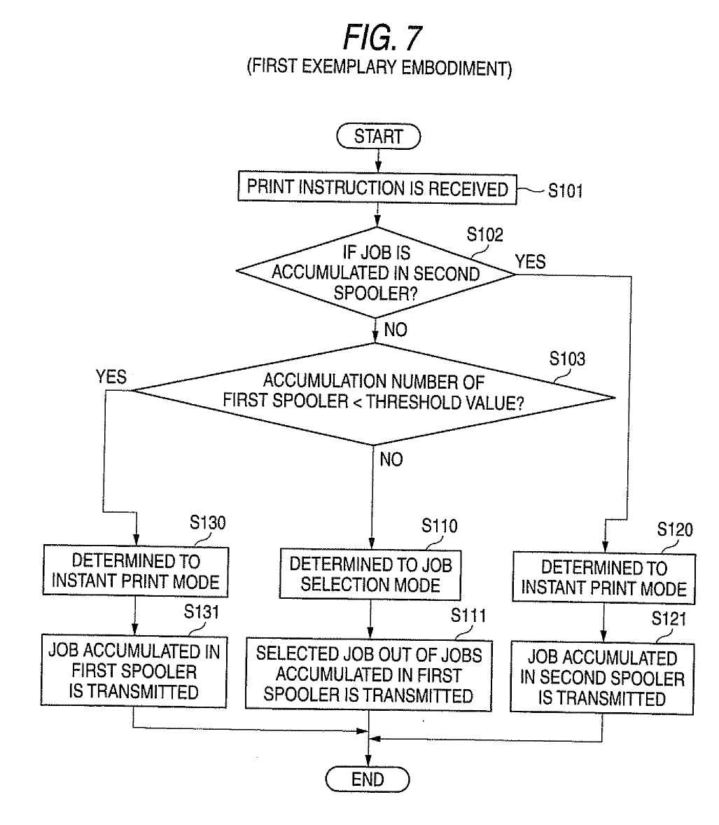

Then, one example of the output processing of a print job will be described according to the flowchart of FIG. 7. When a user holds the user's own authentication card over the card read unit 40 of the printer 4A, the card read unit 40 performs wireless communication using, for example, an electromagnetic induction action or a radio wave between it and the IC chip embedded in the authentication card, and reads the user name recorded on the IC chip.

Incidentally, the user name may be acquired in the following manner. For example, on the display operation unit 41, an authentication screen for inputting the user name and the password is displayed. The user name inputted by the user to the authentication screen with the display operation unit 41 is acquired.

Then, the control unit of the printer 4A transmits a print instruction recording therein the user name read by the card read unit 40 to the print server 2 via the network 10 (S101)

Then, when the control unit 20 of the print server 2 receives the print instruction from the printer 4A (S101), the mode instruction unit 202 checks whether the print job corresponding to the user name designated by the print instruction has been accumulated in the second spooler 212 or not (S102).

Then, when the print job has been accumulated in the second spooler 212 (S102: Yes), the mode instruction unit 202 determines the operation mode as the instant print mode, and instructs the output unit 203 to output the print job in the instant print mode (S120).

Then, the output unit 203 receives an instruction from the mode instruction unit 202. Then, in order to output all the print jobs accumulated in the second spooler 212, it converts the document data which is the data targeted for the print jobs into print data, and successively transmits the print jobs including the converted print data to the printer 4A (S121). Then, the process is completed.

Whereas, when the print job is not accumulated in the second spooler 212 (S102: No), the accumulation number acquisition unit 201 acquires the accumulation number of the print jobs corresponding to the user name in the first spooler 211, and the mode instruction unit 202 compares the acquired accumulation number with the job number threshold value of the threshold value information 213 (S103).

Then, when the accumulation number of the second spooler 212 is less than the job number threshold value (S103: Yes), the mode instruction unit 202 determines the operation mode as the instant print mode, and instructs it to the output unit 203 (S130). Then, the output unit 203 receives an instruction from the mode instruction unit 202, and transmits all the print jobs accumulated in the first spooler 211 to the printer 4A (S121). Then, the process is completed.

On the other hand, in the step S103, when the accumulation number of the second spooler 212 is equal to or more than the job number threshold value (S103: No), the mode instruction unit 202 determines the operation mode as the job selection mode, and instructs it to the output unit 203 (S110).

Then, the output unit 203 receives an instruction from the mode instruction unit 202. Thus, it forms screen information displaying the print jobs accumulated in the first spooler 211 in a list screen, and transmits the print jobs to the printer 4A. Then, a user selects the print job on the list screen displayed on the display operation unit 41 of the printer 4A. The control unit transmits selection information indicative of the selected print job to the print server 2.

Then, the output unit 203 transmits only the print jobs indicated by the transmitted selection information, i.e., the printer jobs selected on the list screen by the user to the printer 4A (S111). Then, the process is completed.

Herein, a description will be given to the print job transmitted to the printer 4A by the print server 2 in the case where each user issues a print instruction to the printer 4A when the first spooler 211, the second spooler 212, and the threshold value information 213 are in the states of FIGS. 3A to 3C, respectively.

When a “user A” issues a print instruction, the print job corresponding to the “user A” has not been accumulated in the second spooler 212 (S102: No). The accumulation number “3” of the first spooler 211 is equal to or more than the job number threshold value “2” of the whole system applied as the job number threshold value of the “user A” (S103: No) Accordingly, the output unit 203 transmits the selected print job (S111) as the job selection mode (S110).

Whereas, when a “user B” issues a print instruction, the print job corresponding to the “user B” has not been accumulated in the second spooler 212 (S102: No). The accumulation number “1” of the first spooler 211 is less than the job number threshold value “3” the “user B” (S103: Yes) Accordingly, the output unit 203 transmits all the print jobs accumulated in the first spooler 211 (S131) as the instant print mode (S131).

Further, when a “user C” issues a print instruction, the print job corresponding to the “user C” has been accumulated in the second spooler 212 (S102: Yes). Accordingly, the output unit 203 transmits all the print jobs accumulated in the second spooler 212 (S121) as the instant print mode (S120).

In the foregoing manner, the print job transmitted from the print server 2 is received by the printer 4A. Then, the control unit of the printer 4A forms image data for print out from the print data included in the received print job. Then, the image data is printed on a sheet according to the print conditions of the print job by the print unit. Then, the print processing is completed.

### Second Exemplary Embodiment

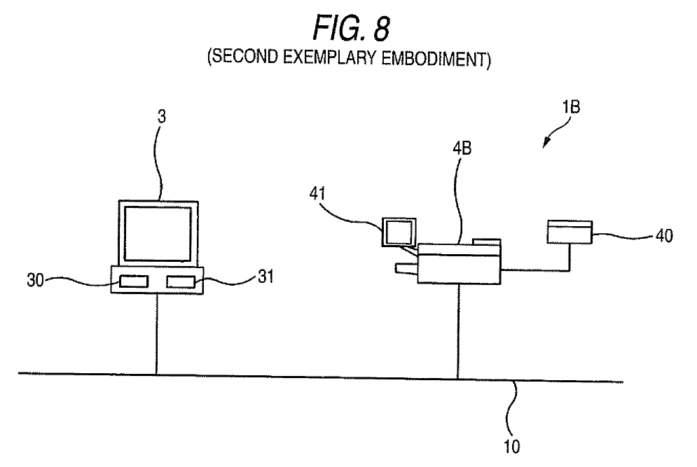

FIG. 8 is a general view showing one example of the schematic configuration of a print system in accordance with a second exemplary embodiment of the invention. With the print system 1A in accordance with the first exemplary embodiment, the print server 2 manages the print jobs. However, with the print system 1B in accordance with this exemplary embodiment, a printer 4B functions as an instruction information management apparatus for managing print jobs.

Namely, the print system 1B in accordance with this exemplary embodiment includes a terminal 3 configured as with the first exemplary embodiment, the printer 4B for managing the print jobs transmitted from the terminal 3, and executing a print processing based on a print job in response to a print instruction, and a network 10 for connecting the terminal 3 and the printer 4B to each other.

(Printer)

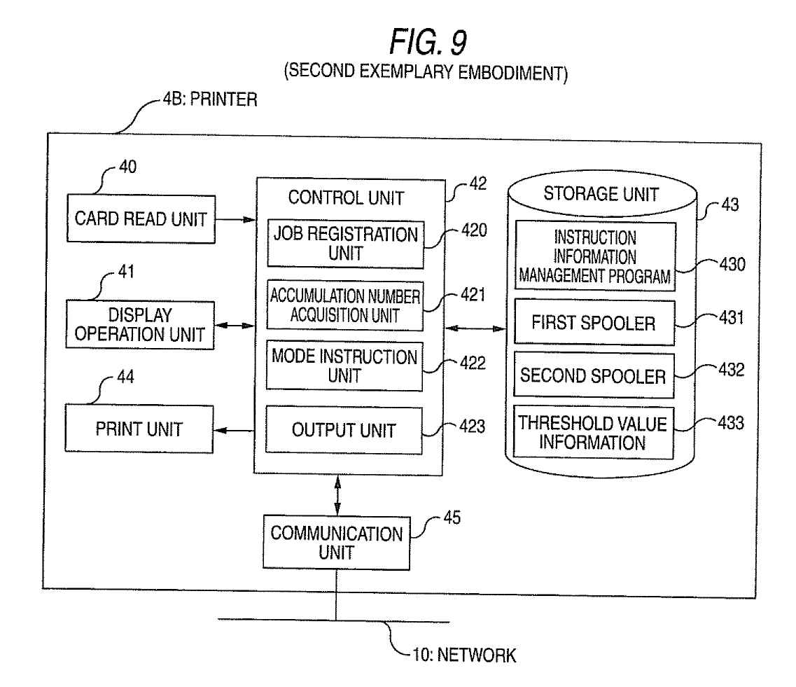

FIG. 9 is a block view showing one example of the schematic configuration of the printer 4B. The printer 4B includes a card read unit 40, a display operation unit 41, a control unit 42, a storage unit 43, a print unit 44, and a communication unit 45, which are the same as those of the printer 4A of First Exemplary embodiment.

The storage unit 43 stores therein an instruction information management program 430, a first spooler 431, a second spooler 432, threshold value information 433, and the like, corresponding to respective information items stored in the storage unit 21 of the print server 2 of First Exemplary embodiment, respectively.

The control unit 42 operates according to the instruction information management program 430, and thereby functions as a job registration unit 420, an accumulation number acquisition unit 421, a mode instruction unit 422, an output unit 423, and the like corresponding to respective unit which the control unit 20 of the print server 2 has, respectively.

In the foregoing configuration, when the printer 4B receives a print job transmitted from the terminal 3, the job registration unit 420 registers the print job to either of the first or second spooler 431 or 432 based on the setting of the operation mode included in the print job, and the comparison result of the accumulation number of the second spooler 432 and the threshold number information 433.

Then, when the printer 4B receives a print instruction via the card read unit 40, the mode instruction unit 422 determines the operation mode based on the presence or absence of the print jobs accumulated in the second spooler 432, and the comparison result of the accumulation number of the first spooler 431 and the threshold number information 433, and instructs it to the output unit 203.

Then, the output unit 423 receives an instruction form the mode instruction unit 422. Then, when the instructed operation mode is the instant print mode, the output unit 423 transmits all the print jobs accumulated in the first or second spooler 431 or 432 to the print unit 44. Whereas, when the instructed operation mode is the job selection mode, the output unit 423 transmits the print job selected by the user out of the print jobs accumulated in the first spooler 431 to the print unit 44.

Then, the print unit 44 executes a print processing based on the print job received from the output unit 423. Then, the process is completed.

### Other Exemplary Embodiments

Incidentally, the present invention is not limited to the foregoing respective exemplary embodiments. Various modifications can be made within the scope not departing from the gist of the invention. For example, in the foregoing respective exemplary embodiments, the job registration unit, the accumulation number acquisition unit, the mode instruction unit, and the output unit of the print server 2 and the printer 48 are implemented by the control unit and the instruction information management program. However, a part of or all of them may be implemented by hardware such as an application-specific integrated circuit (ASIC: Application Specific IC)

Whereas, the instruction management program for use in the foregoing respective exemplary embodiments may be read into the storage unit in the apparatus from a recording medium such as a CD-ROM, or may be downloaded into the storage unit in the apparatus from a server or the like connected to a network such as the Internet.

Further, the constituent elements of the foregoing exemplary embodiments may be arbitrarily combined within the scope not departing from the gist of the invention. For example, the print system in the foregoing respective exemplary embodiments may have the functions, data, and the like which the print server and the printer have as the whole print system. For example, the following configuration is acceptable. An apparatus having a storage unit is added to the print system. Both of or either of the first and second spoolers is stored in the apparatus.

Still further, in the foregoing respective exemplary embodiments, the web browser 30 of the terminal 3 displays a print setting screen, and receives an input of a print job. However, in place of the web browser 30, the print setting screen may be displayed by a printer driver to receive an input of a print job.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a program causing a computer to execute a process for controlling print mode, the process comprising:
accumulating successively inputted print instruction information items in an accumulation region until an output instruction to a print device is issued;
outputting to the print device in an instructed mode of a first mode and a second mode based on the output instruction,
wherein selected instruction print information items out of the accumulated print instruction information items are outputted in the first mode, and
all the accumulated print instruction information items are outputted in the second mode.

2. The computer readable medium according to claim 1,
wherein the outputting includes giving, upon receipt of an output instruction to the print device, a priority to the second mode.

3. The computer readable medium according to claim 1,
wherein the accumulating includes accumulating, (i) when the number of the print instruction information items accumulated in the accumulation region in association with the second mode is less than a threshold value, a print instruction information item including information which indicates the print instruction information item is to be associated with the second mode into the accumulation region in association with the second mode, and (ii) when the number of the print instruction information items accumulated in the accumulation region in association with the second mode is equal to, or more than the threshold value, the print instruction information item including information which indicates the print instruction information item is to be associated with the second mode into the accumulation region in association with the first mode.

4. An instruction information management apparatus, comprising:
an accumulation unit that accumulates successively inputted print instruction information items in an accumulation region until an output instruction to a print device is issued;
an output unit that outputs to the print device in an instructed mode of a first mode and a second mode based on the output instruction,
wherein the output unit outputs, in the first mode, selected instruction print information items out of the accumulated print instruction information items, and
the output unit outputs, in the second mode, all the accumulated print instruction information items.

5. An instruction information management apparatus according to claim 4, further comprising:
the print device,
wherein the print device executes a print processing based on the print instruction information items outputted from the output unit.

6. The instruction information management apparatus according to claim 4,
wherein the outputting includes giving, upon receipt of an output instruction to the print device, a priority to the second mode.

7. The instruction information management apparatus according to claim 4,
wherein the accumulating unit, when the number of the print instruction information items accumulated in the accumulation region in association with the second mode is less than a threshold value, accumulates, into the accumulation region in association with the second mode, a print instruction information item including information which indicates the print instruction information item is to be associated with the second mode, and
the accumulating unit, when the number of the print instruction information items accumulated in the accumulation region in association with the second mode is equal to, or more than the threshold value, accumulates, into the accumulation region in association with the first mode, the print instruction information item including information which indicates the print instruction information item is to be associated with the second mode.

8. An instruction information managing method comprising:
accumulating successively inputted print instruction information items in an accumulation region until an output instruction to a print device is issued;
outputting to the print device in an instructed mode of a first mode and a second mode based on the output instruction,
wherein selected instruction print information items out of the accumulated print instruction information items are outputted in the first mode, and
all the accumulated print instruction information items are outputted in the second mode.

9. The instruction information managing method according to claim 8,
wherein the accumulating includes accumulating, (i) when the number of the print instruction information items accumulated in the accumulation region in association with the second mode is less than a threshold value, a print instruction information item including information which indicates the print instruction information item is to be associated with the second mode into the accumulation region in association with the second mode, and (ii) when the number of the print instruction information items accumulated in the accumulation region in association with the second mode is equal to, or more than the threshold value, the print instruction information item including information which indicates the print instruction information item is to be associated with the second mode into the accumulation region in association with the first mode.
